(19) United States
(12) Patent Application Publication
(10) Pub. No.: US 2002/0149472 A1
(43) Pub. Date: Oct. 17, 2002

(54) Medication control and dispensing box

(76) Inventor: Bonnie A. Roe, Tuscola, TX (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/833,931

(22) Filed: Apr. 11, 2001

(51) Int. Cl. G08B 1/00

(52) U.S. Cl. 340/309.15; 340/573.1; 340/570

(57) ABSTRACT

A medication dispensing apparatus for control of medication usage of a patient comprises a container box providing seven removable drawers, each drawer providing four medication compartments with each compartment sealed by a time-controlled door. A programmable control system is enabled for releasing a latch on each of the doors in accordance with a medication dispensing program. An audio device announces medication instructions.

### BACKGROUND OF THE INVENTION

1. Field of the Invention

This invention relates generally to medication storage and dispensing boxes and more particularly to a combination medication dispensing box with a variety of useful features.

2. Description of Related Art

The prior art teaches the use of medication storage bottles and dispensing boxes but does not teach a storage box with removable sections related to particular days of the week, nor a box that may be programmed to provide audible instructions and features for improved understanding by the impaired. The present invention fulfills these needs and provides further related advantages as described in the following summary.

### SUMMARY OF THE INVENTION

The present invention teaches certain benefits in construction and use which give rise to the objectives described below.

A medication dispensing apparatus for control of medication usage of a patient comprises a container box providing seven removable drawers, each drawer providing four medication compartments with each compartment sealed by a time-controlled door. A programmable control system is enabled for releasing a latch on each of the doors in accordance with a medication dispensing program. An audio device announces medication instructions.

A primary objective of the present invention is to provide an apparatus and method of use of such apparatus that provides advantages not taught by the prior art.

Another objective is to provide such an invention capable of being easily operated.

A further objective is to provide such an invention providing automation for control of a medication schedule.

A still further objective is to provide such an invention capable of dispending medication in a manner such that over medicating and under medicating is not possible.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention;

FIG. 2 is a perspective view of one drawer thereof.

FIG. 3 is a partial perspective view thereof showing assembly of an audible element;

FIG. 4 is partial perspective view of raised and lighted lettering thereof;

FIG. 5 is a side view thereof showing utility access ports; and

FIG. 6 is a bottom view thereof.

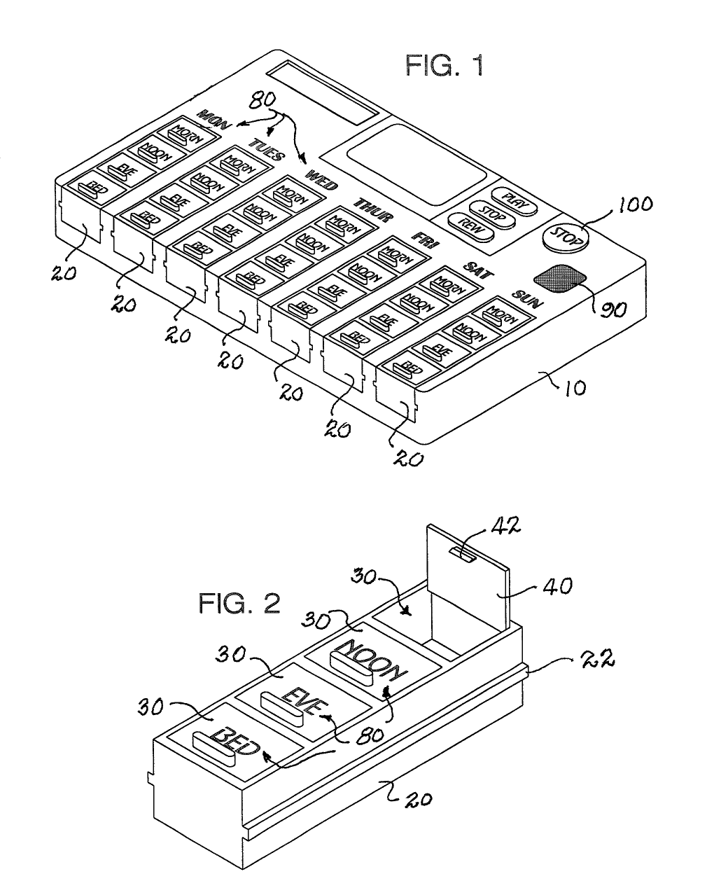

### DETAILED DESCRIPTION OF THE INVENTION

The above described drawing figures illustrate the invention in at least one of its preferred embodiments, which is further defined in detail in the following description.

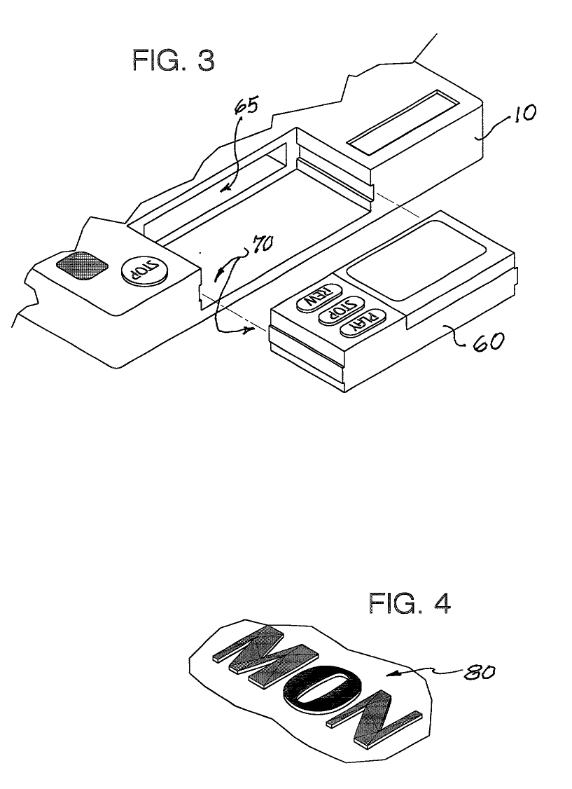

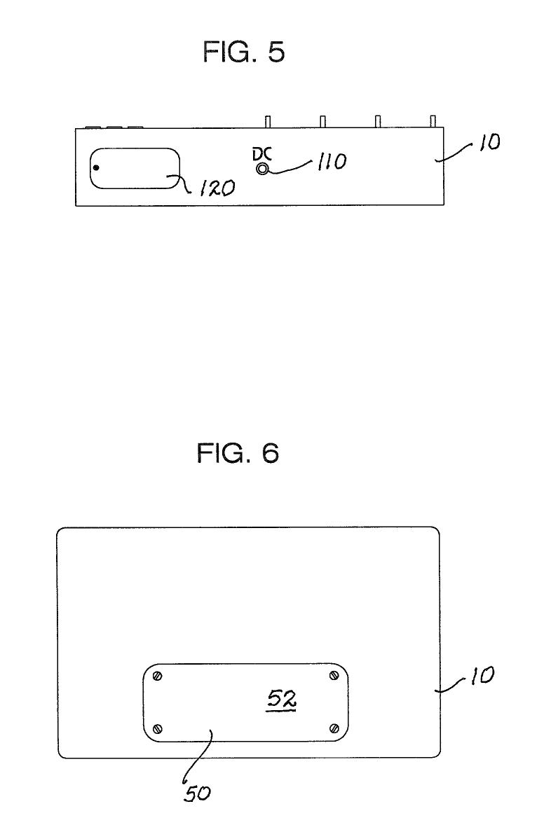

The present invention is a medication dispensing apparatus for control of medication usage for a patient. A container box 10 provides seven removable drawers 20. The drawers are removable to provide more convenient filling and slide on rails 22 which provide for convenient mechanical engagement and also electrical interconnection. Each drawer provides four medication compartments 30 with each compartment sealed by a time-controlled door 40. A programmable control system 50, such as a common micro-controller, is enabled, in any manner well known in the art, for releasing a latch 42 on each of the doors 40 in accordance with a medication dispensing program (software program). Such a program is a software driven process stored in the programmable control system 50. An audio means 60, such as a tape recorder or solid state storage device, is enabled by the control system 50, for announcing medication instructions at programmed medication times. A means for removably engaging 70 the audio means with the container box is shown in FIG. 3 and includes a slot-way for sliding the audio means 60 into the container box 10 and for electrical interconnection therewith. The audio means 60 is removable for more convenient programming and setting-up of an audio tape to be used for instructing the patient. Also, it conceals a compartment 65 which may be used for storing spare audio tapes. Indicia 80 identifying the seven drawers with the days of the week respectively, is provided, as well as identifying the time controlled doors with set dispensing periods such as at meal and bedtimes. In the preferred embodiment these indications are “Morn,” “Noon,” “Eve” and “Bed.” These indicia preferably comprise raised letters as shown in FIG. 4, and are preferably lighted from within the container box 10 so as to be more easily seen in low ambient lighting conditions and by the visually impaired. Also, the indicia are of such size as to be more easily visible to the visually impaired. The dispensing program enables an audible alarm 90 in accordance with the medication dispending schedule and in correspondence with control of the time controlled doors 42. Preferably, the drawers 42 are color coded so as to be more easily comprehended by the aged and infirm. A “Stop” button 100 is provided to silence the alarm. A door 52 (FIG. 6) is mounted on the bottom of the container box 10 and conceals a control panel or device (not shown) for programming the control system 50. This location of the control panel 50 is made so that the patient is not likely to be able to gain access to change control times and other programming. Such control systems are very well known and in common practice in devices such as hand held data managers and such, so that details of construction and use are not considered necessary in the present disclosure. In FIG. 5 is shown the location of a receptacle 110 for a DC power input device (not shown) and a compartment 120 for battery (not shown).

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A medication dispensing apparatus for control of medication usage for a patient which comprises: a container box providing seven removable drawers, each drawer providing four medication compartments with each said compartment sealed by a time-controlled door; a programmable control system enabled for releasing a latch on each of the doors in accordance with a medication dispensing program, and an audio means enabled for announcing medication instructions.

2. The apparatus of claim 1 further comprising a means for removably engaging the audio means with the container box.

3. The apparatus of claim 1 further comprising indicia identifying the seven drawers with the days of the week respectively.

4. The apparatus of claim 3 wherein the indicia further identifies the time controlled doors with set dispensing periods.

5. The apparatus of claim 4 wherein the indicia comprise raised letters.

6. The apparatus of claim 5 wherein the indicia are lighted.

7. The apparatus of claim 6 wherein the indicia are of such size as to be visible to the visually impaired.

8. The apparatus of claim 1 wherein the dispensing program enables an audible alarm in accordance with the medication dispending schedule and in correspondence with control of the time controlled doors.

9. The apparatus of claim 1 wherein the drawers are color coded.

10. The apparatus of claim 1 wherein the audio means is removable from the container box and conceals a storage space therein.
